(19) United States
(12) Patent Application Publication
(10) Pub. No.: US 2012/0053861 A1
(43) Pub. Date: Mar. 1, 2012

(54) ON-LINE MONITORING AND PREDICTION OF CORROSION IN OVERHEAD SYSTEMS

(75) Inventors: Lawrence N. KREMER, The Woodlands, TX (US); Huzeifa Ismail, Houston, TX (US); Greorge G. Duggan, Katy, TX (US); Joel E. Lack, Sugar Land, TX (US); Randy G. Rechtien, St. Louis, MO (US); Jerry J. Weers, Richmond, TX (US)

(73) Assignee: BAKER HUGHES INCORPORATED, Houston, TX (US)

(21) Appl. No.: 13/115,557

(22) Filed: May 25, 2011

Related U.S. Application Data
(60) Provisional application No. 61/377,122, filed on Aug. 26, 2010.

(51) Int. Cl. G06F 19/00

(52) U.S. Cl. 702/50

(57) ABSTRACT

The present disclosure describes a method and system for estimating the onset of salt formation in an overhead fluid system. The method may include measuring parameters of a process stream by collecting data from one or more sensor arrays on an overhead line, such as from a distillation column, and then estimating the onset of salt formation corrosion using the data from the sensor arrays. The method may be implemented in real-time. The method may include transmitting data to monitoring facilities and/or sending instructions to alarms and/or regulators. Also described is a system for performing the method.

### CROSS-REFERENCES TO RELATED APPLICATIONS

This application claims priority from U.S. Provisional Patent Application Ser. No. 61/377,122, filed on 26 Aug. 2010, the disclosure of which is incorporated herein by reference in its entirety.

### FIELD OF THE DISCLOSURE

This disclosure generally relates to inhibiting corrosion in liquid hydrocarbon facilities and, in particular, detecting the onset of salt formation in overhead fluid systems and inhibiting said salt formation.

### BACKGROUND OF THE DISCLOSURE

In a hydrocarbon refinery, a crude unit may clean oil through water washing in a desalter and then split the oil into fractions in an atmospheric distillation tower. These fractions are pumped to various processing units downstream of the crude unit (e.g., coker, catalytic cracker, hydrotreater etc.). When leaving the distillation tower, the hydrocarbons may travel through an overhead fluid system. Acids contained in these fractions may undesirably cause corrosion in the overhead systems. These acids may be conventionally neutralized with basic amine additives. Changes in environmental or chemical conditions of the hydrocarbon fluids in the overhead fluid system may lead to the formation of amine salts that may themselves cause corrosion of the overhead fluid pipe(s). These changes may also lead to the hydrocarbon fluid passing through the dew point of water contained therein. The term “dew point” refers to the point of initial condensation of steam to water or the temperature at which a phase of liquid water separates from the water vapors and liquid hydrocarbons and begins to form liquid water as the vapors cool. The liquid water may have amine salts dissolved therein which will dissolve and dissociate in the water decreasing the pH of the water to an acid pH that also contributes to corrosion of the overhead fluid piping.

Refinery crude unit processing can be challenging and complex, and most of the corrosion in overhead fluid systems may take place during periods where corrosion parameters difficult to measure and evaluate. It is not uncommon for the period between sample collection, analysis, and results reporting for an overhead fluid system to span three weeks. This lengthy period leads to some systems only being tested one to three times per calendar year. Attempts to compensate for intermittent or long period corrosion monitoring have included installing online pH meters on atmospheric distillation towers overhead accumulator water boots, however, these systems are often used to detect the formation of acids in the liquid phase of water after the fluid has passed its dew point. Since the detection methods focus on the detection of pH changes in the liquid water phase, the salt formation corrosion has already begun before the pH change is detected. Since the water in the fluid may reach its dew point in any overhead equipment, such as along the length of the overhead pipes, the pH based methods tend to only address acid based corrosion downstream of the location where the dew point occurred. Thus, there is an ongoing need for on-line and automated methods for monitoring the onset of amine salt formation to reduce corrosion in overhead fluid systems since such methods would address corrosives prior to the formation of acids and along piping segments upstream of the dew point location.

### SUMMARY OF THE DISCLOSURE

In aspects, this disclosure generally relates to inhibiting corrosion in liquid hydrocarbon facilities and, in particular, detecting the onset of salt formation in overhead fluid systems and inhibiting said salt formation.

One embodiment according to the present disclosure includes a method for estimating the onset of corrosive species formation in an overhead fluid system, comprising: estimating the onset of salt formation in the overhead fluid system using a value of at least one parameter of a fluid selected from the group consisting of: pH, temperature, pressure, composition, density, flow rate, total steam, presence or level of a compound selected from the group consisting of: chloride, total amine, total nitrogen, halogen, bromide, iodide, oxygen, water, ammonia level, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutylamine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine, diisobutylamine, triethylamine, dimethylaminopropylamine, and combinations thereof, and combinations thereof.

Another embodiment according to the present disclosure includes a system for estimating corrosive species formation in an overhead fluid system, comprising: an array of sensors comprising: a pH sensor; a chloride sensor; a nitrogen sensor, where the nitrogen sensor is selected from a group consisting of: an ammonia sensor, a total amine sensor, a total nitrogen sensor, and combinations thereof; a processor; a memory storage device, the memory storage devices including instructions that, when executed, cause the processor to perform a method, the method comprising: estimating the onset of corrosive species formation in the overhead fluid system using a value at least one parameter of a fluid selected from the group consisting of: pH, chloride, total amine, total nitrogen, and ammonia.

Another embodiment according to the present disclosure includes a computer readable medium product having stored thereon instructions that, when executed by at least one processor, perform a method the method comprising: estimating an onset of corrosive species formation in real-time in an overhead fluid system using a value at least one parameter of a fluid where the fluid parameter is selected from the group consisting of: pH, temperature, pressure, composition, density, flow rate, total steam, presence or level of a compound selected from the group consisting of: chloride, total amine, total nitrogen, ammonia, halogen, bromide, iodide, oxygen, water, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutylamine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine, diisobutylamine, triethylamine, dimethylaminopropylamine, and combinations thereof, and combinations thereof.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 is a schematic of an exemplary embodiment of a system for estimating the onset of salt formation according to one embodiment of the present disclosure;

FIG. 2 shows a method according to one embodiment of the present disclosure;

FIG. 3 is a schematic of a computer-readable medium configured to execute a method according to one embodiment of the present disclosure; and

FIG. 4 shows another method according to one embodiment of the present disclosure.

### DETAILED DESCRIPTION OF THE DISCLOSURE

The present disclosure relates to methods and systems for inhibiting corrosion in liquid hydrocarbon facilities and, in particular, detecting the onset of salt formation in overhead fluid systems and inhibiting said salt formation. Overhead fluid systems may contain one or more hydrocarbons, non-condensable gases, and water. The water may be in a liquid or vapor phase depending on the system temperature/pressure.

Corrosive species, such as salt and acids formed when salts dissolve in liquid water, are primary contributors to corrosion in hydrocarbon processing. Hence, corrosion control plays a vital role in maintaining system integrity. The present disclosure provides methods and systems for inhibiting acid and salt formation corrosion by monitoring the onset of corrosive species formation. Sensors may be used to obtain data about salt formation predictors, including, but not limited to, one or more of: pH, temperature, pressure, density, flow rate, water wash rate, total steam, hardness, presence or levels of one or more of: chloride, total amine, total nitrogen, ammonia, halogen, bromide, iodide, oxygen, water, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutylamine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine, diisobutylamine, triethylamine, dimethylaminopropylamine, sodium, calcium, magnesium, free oxygen, iron, nickel, copper, chromium, manganese, zinc, molybdenum, titanium, and combinations thereof, and combinations thereof. While high fluid velocities do not cause corrosion, high fluid velocities may aggravate corrosion. However, water wash systems configured to prevent the onset of corrosive species may suffer reduced effectiveness if the water wash rate falls below a required minimum for a given overhead wet hydrocarbon fluid system configuration. Collectively these are fluid parameters. Also, by the term “level” is meant proportion or quantity. A value of a fluid parameter may include, but is not limited to, one of: (i) an amount, (ii) a concentration, (iii) a proportion, (iv) a ratio, and (v) a rate. By inputting the data from the sensors (along with static information such as piping parameters) into a model, the onset of salt formation may be estimated. Herein, “onset” may refer to the actual event of salt formation or a predictive future event of salt formation. The model for processing the data may include, but is not limited to, at least one of: a mathematical model and a nomograph. In some aspects, a safety margin may be proscribed between the current conditions and a known point where salt formation will occur. When operating on the safe side of the safety margin, corrosion may be markedly reduced.

Some embodiments may include sensors used to obtain acid corrosion predictors, including, but not limited to, levels of one or more of: halogens (fluoride, bromide, etc.), organic acids (formic, acetic, propionic, buteric, valeric, etc.) and sulfur species (bisulfide, sulfide, sulfate, thiosulfate, sulfite, etc.). Some embodiments may include sensors for estimating the onset of salt formation and estimating acid corrosion predictors.

Overhead fluid systems, such as those coming from a distillation unit, have highly unique and variable environments, especially in terms of temperature, pressure, and flow rates. Over the length of an overhead fluid system, while the temperature declines, the aqueous fluids and/or hydrocarbon fluids within may change phase and/or phases may drop out of the hydrocarbon process stream. Different fluids may drop out at different times and locations along the journey of the process stream through the overhead fluid system. One key location along the overhead piping may be the position where the water dew point occurs, such as in, but not limited to, overhead piping, upper sections of a distillation tower, overhead system condensing equipment, and overhead system water separation equipment. A key contributor to acidic corrosion in an overhead fluid system at the water dew point is the presence of hydrochloric acid. Sensors may be used to identify the sections of the overhead pipe where conditions are right for liquid water to condense or drop out of the process stream.

The present disclosure includes sensors positioned so that changes in parameters, such as temperature, pressure, flow rate, hydrogen permeation, resistivity of the overhead pipe, and corrosimeter probe data may be measured at multiple points along the overhead fluid system. The sensors may be positioned at various locations including the overhead and the accumulator of an overhead fluid system. Parameters that are relatively insensitive to position along the overhead fluid system may be measured at a single location. The sensors may be configured for periodic, continuous, or ad hoc operation, and a controller may be configured to apply the sensor data to the model on a periodic, continuous (real-time), or ad hoc basis. Herein, “real-time” includes sufficient monitoring continuity such that a change in the sensor data may be detected within a few seconds or a few minutes. The term “controller” refers to a manual operator or an electronic device having components such as a processor, memory device, digital storage medium, cathode ray tube, liquid crystal display, plasma display, touch screen, or other monitor, and/or other components. The controller is preferably operable for integration with one or more application-specific integrated circuits, programs, computer-executable instructions or algorithms, one or more hard-wired devices, wireless devices, and/or one or more mechanical devices. Moreover, the controller is operable to integrate the feedback, feed-forward, or predictive loop(s) of the system. Some or all of the controller system functions may be at a central location, such as a network server, for communication over a local area network, wide area network, wireless network, internet connection, microwave link, infrared link, and the like. In addition, other components such as a signal conditioner or system monitor may be included to facilitate signal transmission and signal-processing algorithms. In some embodiments, a controller may provide instructions to various components (e.g., chemical injection pumps). The controller may be automated, semi-manual, or manual. In some embodiments, the controller may receive data from the sensors real-time via a computer network.

When the onset of salt formation is estimated, the system may be configured to send an alarm to an operator. The system may also be configured to provide instructions or control parameters to inhibit salt formation. Controllable parameters may include, but are not limited to, one or more of: (i) temperature, (ii) pressure, (iii) flow rate, (iv) water wash rate, (v) total steam, (vi) amount of additive, (vii) location of additive injection and (viii) type of additive. Total steam may include the quantity of steam added to a distillation tower. Since acids may be neutralized by the introduction of amine additives and amine salts may be formed when certain amine additives are increased, there may be circumstances where amine salt formation corrosion may be increased due to efforts to neutralize acid corrosion. In some embodiments, amine salt formation may be inhibited by selecting the amine used to neutralize acid corrosion to avoid amine salt formation.

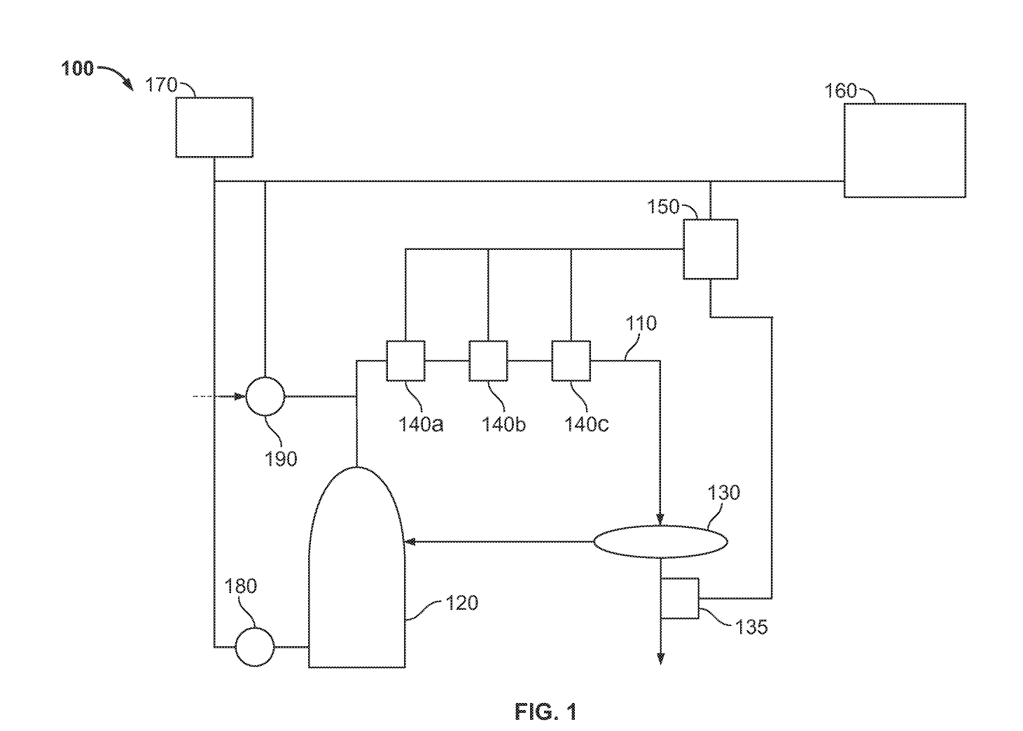

FIG. 1 shows an exemplary system 100 according to one embodiment of the present disclosure. An overhead fluid system 110 may transport a process stream from a distillation tower 120. Liquid water (water condensate) may drop out of the process stream along the length of the overhead 110 and eventually accumulate in an accumulator 130. Along the length of the overhead 110 may be positioned a series of sensor arrays 140a-c. Each of the sensor arrays 140a-c may include at least one sensor to measure parameters of the fluid stream. The sensor arrays 140a-c may include the same or different sensors as required for a particular installation. In some embodiments, sensor arrays 140a-c may include at least sensors for estimating pH, chloride, and a component selected from the group of: (i) ammonia, (ii) total amine, (iii) total nitrogen, and combinations thereof. In some embodiments, the sensor arrays 140a-c may be configured to analyze overhead gas composition and/or perform gas chromatography. The sensors 140a-c may transmit data to the controller 150, which may process the data and apply the data to a model for estimating the onset of salt formation. In some embodiments, the sensor arrays 140a-c and model may be configured for estimating corrosivity. When estimating the onset of acid corrosion, one or more of sensor arrays 140a-c may be configured to estimate ion concentrations of metals, including, but not limited to, one or more of: (i) iron, (ii) copper, (iii) molybdenum, (iv) nickel, (v) chromium, (vi) manganese, (vii) titanium, and (viii) zinc. Some embodiments may also include a sensor array 135 on the accumulator 130, which may be configured to complement or duplicate functions of sensor arrays 140a-c. In some embodiments, sensor arrays 140a-c may be replaced by sensor array 135 at accumulator 130. In some embodiments, the amine levels may be estimated at the accumulator 130, while non-chemical parameters (i.e. temperature, pressure, flow rate, hydrogen permeation, overhead pipe resistivity, and/or corrosimetry) may be measured at the overhead 110 with sensor arrays 140a-c. In some embodiments, the sensor array (not shown) at the accumulator 130 may be configured receive a sample of the water condensate and to perform one or more chemical analyses on condensate water from the accumulator 130. The chemical analyses may include, but are not limited to, one or more of: colorimetric titration, potentiometric titration, ion chromatography, atomic absorption, x-ray florescence, ion specific electrodes, and Karl Fisher titration. Information from the one or more of sensor arrays 140a-c, 135 may be collected by controller 150, which may be configured to relay the data to a monitoring computer or monitoring station 160 for recording or viewing by plant personnel. Monitoring data may also be related to remote locations via a computer network or The Internet. In some embodiments, data from sensors at other locations of the refining facility (desalter temperature, etc.) may be received by controller 150 for estimating the onset of a corrosive condition.

If the onset of a corrosive condition is determined, the controller 150 may send instruction to an alarm or notification system 170, an environmental regulator 180, and/or an additive/chemical regulator 190. The environmental regulator 180 may be configured to alter one or more of the pressure, temperature, flow rate, water wash rate, or phase of the process stream. In some embodiments, environmental regulator 180 may include one or more of: (i) a temperature regulator, (ii) a pressure regulator, (iii) a flow regulator, and (iv) a water wash regulator. The additive regulator 190 may be configured to inject estimated amounts and/or types of additive to the process stream to inhibit salt formation. Additives may be added to the process stream at any point along the process stream, including, but not limited to, one or more of: the overhead fluid system piping and the tower feed stream. Additives that may be injected to inhibit acid corrosion may include, but are not limited to, one or more of: water, sodium hydroxide, potassium hydroxide, lithium hydroxide, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutylamine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine diisobutylamine, triethylamine, and dimethylaminopropylamine. In some embodiments, additive regulator 190 may include a neutralizing amine pump and a filming amine pump. In some embodiments, the controller 150 may be manually overridden or automatically overridden by high priority instructions. The amount, type, and/or location of the additive injected into the process stream may be selected based on information from one or more of the sensor arrays 135, 140a-c., such as pH, chloride level, ammonia, total nitrogen, and estimated water dew point pH.

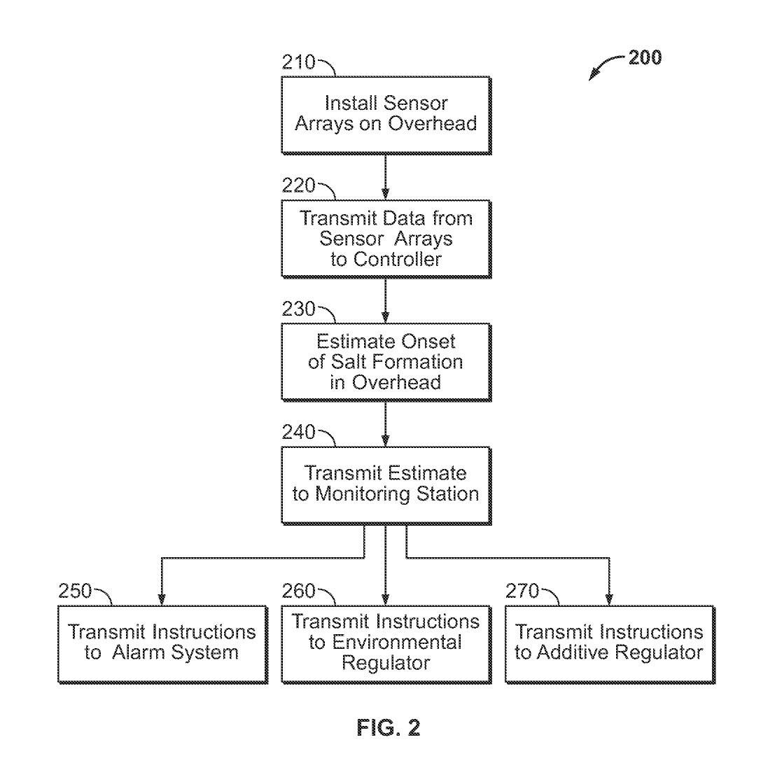

FIG. 2 shows an exemplary method 200 for using the system 100 according to one embodiment of the present disclosure. In step 210, sensor arrays 140a-c may be installed on overhead 110. In some embodiments, one or more sensor arrays (not shown) may be installed at the accumulator 130. Installation may be permanent or temporary. In some embodiments, additional sensor arrays (not shown) may be installed at additional locations off of the overhead. The use of three sensor arrays on the overhead is exemplary and illustrative only, as any number of sensor arrays may be used. In some embodiments, one or more of the sensors that make up the sensor arrays 140a-c may be retractable for cleaning, calibration, replacement or other service. In step 220, sensor arrays 140a-c may generate data that may be transmitted to controller 150. In step 230, controller 150 may estimate the onset of salt formation by applying data from the sensor arrays 140a-c to a model. Estimating the onset of salt formation may include: (i) detecting salt formation, (ii) measuring a rate of salt formation, (iii) detecting conditions consistent with salt formation, and (iv) predicting salt formation. In some embodiments, a communication relay may transmit the data to/from a controller 150 that is at a location remote from the hydrocarbon facility. In some embodiments, the model may additionally use other data acquired by other sensors and/or system parameters in the estimation process, including, but not limited to, diameters of pipes, configuration of exchangers, volume of the accumulator, locations of sensors, composition of hydrocarbons in the overhead, and overhead gas composition. One model that may be used is the Ionic Equilibrium Model, however, the use of this model is exemplary and illustrative, as several models may be used that are known to or may be generated by one of skill in the art. In step 240, controller 150 may send information regarding the onset of salt formation in the overhead 110 to a monitoring station 160. In step 250, controller 150 may send instructions to an alarm or notification system 170. In step 260, controller 150 may send instructions to an environmental regulator 180. And, in step 270, controller 150 may send instructions to an additive/chemical regulator 190 to add an amount or type of additive to be injected into the overhead 110. The instructions to add an additive may include (i) increasing an amount of at least one additive to be added, (ii) decreasing an amount of at least one additive to be added, (iii) maintaining a existing amount of an additive to be added, and (iv) increasing an amount of at least one additive to be added while decreasing the amount of at least one other additive to be added and combinations thereof. In some embodiments, steps 250, 260, and 270 may occur simultaneously or separated by intervals. In some embodiments some or all of steps, except for 230, may be optional.

In support of the teachings herein, various analysis components may be used in the controller 150 and/or monitor 160, including digital and/or analog systems. The controller 150 and/or monitor 160 may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present disclosure. These instructions may provide for equipment operation, control, data collection and analysis and other functions deemed relevant by a system designer, owner, user or other such personnel, in addition to the functions described in this disclosure.

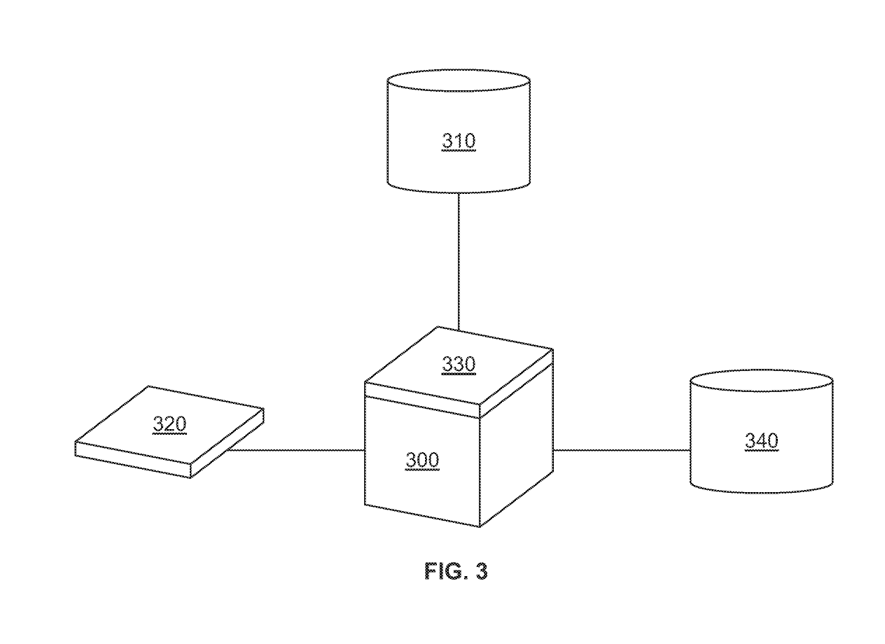

As shown in FIG. 3, certain embodiments of the present disclosure may be implemented with a hardware environment that includes an information processor 300, a data storage medium 310, an input device 320, processor memory 330, and may include peripheral data storage medium 340. The input device 320 may be any data reader or user input device, such as data card reader, keyboard, USB port, etc. The data storage medium 310 stores formation characteristic data provided by a user or user system. Data storage medium 310 may be any standard computer data storage device, such as a USB drive, memory stick, hard disk, removable RAM, or other commonly used memory storage system known to one of ordinary skill in the art including Internet based storage. Data storage medium 310 stores a program that when executed causes information processor 300 to execute the disclosed method. Data storage medium 310 may also store the formation data provided by the user, or the formation data may be stored in a peripheral data storage medium 340, which may be any standard computer data storage device, such as a USB drive, memory stick, hard disk, removable RAM, or other commonly used memory storage system known to one of ordinary skill in the art including Internet based storage. Information processor 300 may be any form of computer or mathematical processing hardware, including Internet based hardware. When the program is loaded from data storage medium 310 into processor memory 330 (e.g. computer RAM), the program, when executed, causes information processor 300 to retrieve formation data from either data storage medium 310 or peripheral data storage medium 340 and process the formation data to characterize the formation.

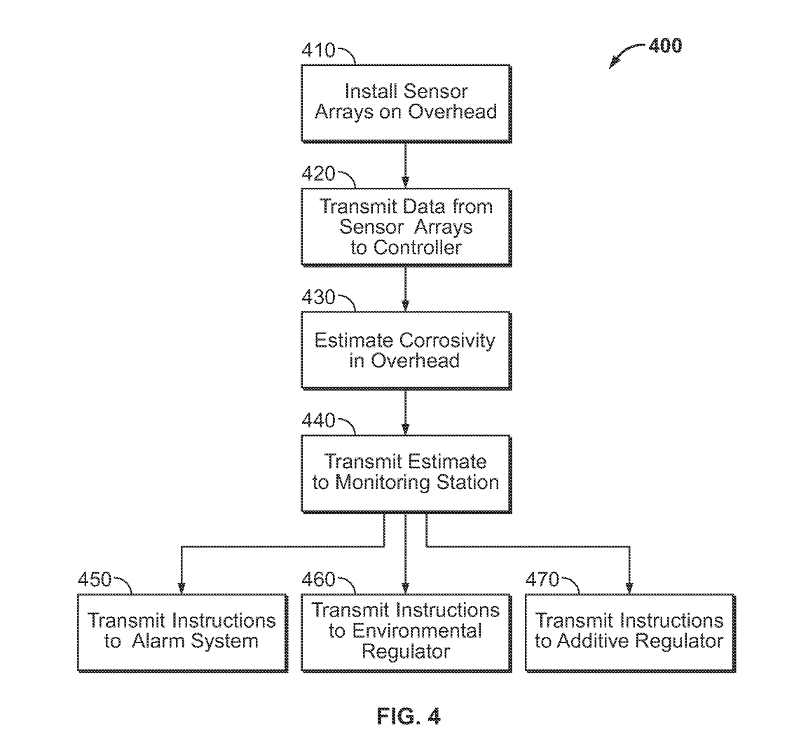

FIG. 4 shows an exemplary method 400 for using the system 100 according to one embodiment of the present disclosure. In step 410, sensor arrays 140a-c may be installed on overhead 110. In some embodiments, one or more sensor arrays (not shown) may be installed at the accumulator 130. In step 420, sensor arrays 140a-c may generate data that may be transmitted to controller 150. In step 430, controller 150 may estimate corrosivity by estimating the amount of acids or acid predictors in the overhead 110 and applying data from the sensor arrays 140a-c to a model. Estimating the amount of acids may include: (i) detecting the presence of one or more acids and/or (ii) measuring a concentration of one or more acids. Estimating acid predictors may include (i) detecting the presence of metal ions and/or (ii) measuring a concentration of metal ions. In some embodiments, a communication relay may transmit the data to/from a controller 150 that is at a location remote from the hydrocarbon facility. In some embodiments, the model may additionally use other data acquired by other sensors and/or system parameters in the estimation process, including, but not limited to, diameters of pipes, configuration of exchangers, volume of the accumulator, locations of sensors, composition of hydrocarbons in the overhead, and overhead gas composition. One model that may be used is the Ionic Equilibrium Model, however, the use of this model is exemplary and illustrative, as several models may be used that are known to or may be generated by one of skill in the art. In step 440, controller 150 may send information regarding corrosivity in the overhead 110 to a monitoring station 160. In step 450, controller 150 may send instructions to an alarm or notification system 170. In step 460, controller 150 may send instructions to an environmental regulator 180. And, in step 470, controller 150 may send instructions to an additive/chemical regulator 190. In some embodiments, steps 450, 460, and 470 may occur simultaneously or separated by intervals. In some embodiments some or all of steps, except for 430, may be optional.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the disclosure disclosed. The probes and methods herein may be non-explosive and/or explosive-proof. The methods and apparatuses may also be advantageously employed at relatively high temperatures, for instance up to 200° C., or even higher.

While the disclosure has been described with reference to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

The words “comprising” and “comprises” as used throughout the claims is to be interpreted to mean “including but not limited to”.

We claim:

1. A method for estimating the onset of corrosive species formation in an overhead fluid system along a process stream, comprising:
estimating the onset of corrosive species formation in the overhead fluid system using a value of at least one parameter of a fluid selected from the group consisting of:
pH,
temperature,
pressure,
density,
flow rate,
water wash rate,
total steam,
presence or level of a compound selected from the group consisting of: chloride, total amine, total nitrogen, halogen, bromide, iodide, oxygen, water, ammonia, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutyl amine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine, diisobutylamine, triethylamine, dimethylaminopropylamine, and combinations thereof, and
combinations thereof.

2. The method of claim 1 where the corrosive species includes a salt.

3. The method of claim 1 where the corrosive species includes an aqueous acid.

4. The method of claim 1 where the at least one parameter includes at least one of those selected from the group consisting of: pH, chloride, total amine, total nitrogen, ammonia, and combinations thereof.

5. The method of claim 1, further comprising:
collecting a sample of the fluid; and
estimating the value of the at least one parameter.

6. The method of claim 1 where the onset of salt formation is estimated using at least one of: (i) a mathematical model and (ii) a nomograph.

7. The method of claim 1 where the onset of salt formation is estimated in real-time.

8. The method of claim 1, further comprising:
adding an amount of an additive to the process stream based on the estimated corrosive species formation in an amount effective to reduce corrosive species formation that would occur absent adding the amount of additive.

9. The method of claim 8 where the additive is selected from at least one of the group consisting of: water, sodium hydroxide, potassium hydroxide, lithium hydroxide, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutylamine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine, and combinations thereof.

10. The method of claim 1, further comprising:
changing a value of at least one other fluid parameter based on the value of the fluid parameter where the fluid parameter is selected from the group consisting of:
pH,
temperature,
pressure,
density,
flow rate,
water wash rate,
total steam,
presence or level of a compound selected from the group consisting of chloride, total amine, total nitrogen, ammonia, halogen, bromide, iodide, oxygen, water, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutyl amine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine, diisobutylamine, triethylamine, dimethylaminopropylamine, and combinations thereof, and
combinations thereof.

11. The method of claim 10 where the at least one other fluid parameter is selected from at least one of the group consisting of: (i) temperature, (ii) pressure, and (iii) flow rate, (iv) water wash rate, (v) total steam, (vi) amount of additive, (vii) location of additive injection, (viii) type of additive, and combinations thereof.

12. The method of claim 1 where the fluid is a mixture including liquid water in which the liquid water has not separated from the mixture.

13. A system for estimating corrosive species formation in an overhead fluid system, comprising:
an array of sensors comprising:
a pH sensor;
a chloride sensor;
a nitrogen sensor, where the nitrogen sensor is selected from a group consisting of: an ammonia sensor, a total amine sensor, a total nitrogen sensor, and combinations thereof;
a processor;
a memory storage device, the memory storage devices including instructions that, when executed, cause the processor to perform a method, the method comprising:
estimating the onset of corrosive species formation in the overhead fluid system using a value at least one parameter of a fluid selected from the group consisting of: pH, chloride, total amine, total nitrogen, and ammonia.

14. The system of claim 13 where the corrosive species includes a salt.

15. The method of claim 13 where the corrosive species includes an aqueous acid.

16. The system of claim 13, further comprising:
an additive injection system.

17. The system of claim 13, further comprising at least one of: (i) a temperature regulator, (ii) a pressure regulator, (iii) a flow regulator, and (iv) a water wash regulator.

18. The system of claim 13, the memory storage device further comprising:
instructions, that when executed, cause the processor to:
change a value of at least one other fluid parameter based on the value of the at least one fluid parameter where the fluid parameter is selected from the group consisting of:
pH,
temperature,
pressure,
density,
flow rate,
water wash rate,
total steam,
presence or level of a compound selected from the group consisting of chloride, total amine, total nitrogen, ammonia, halogen, bromide, iodide, oxygen, water, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutylamine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine, diisobutylamine, triethylamine, dimethylaminopropylamine, and combinations thereof, and
combinations thereof.

19. The system of claim 13, where at least one other fluid parameter is selected from at least one of the group consisting of: (i) temperature, (ii) pressure, (iii) flow rate, (iv) wash water rate, (v) total steam, (vi) amount of additive, (vii) location of additive injection, (viii) type of additive, and combinations thereof.

20. The system of claim 13, the memory storage device further comprising:
instructions, that when executed, cause the processor to:
estimate an amount of additive to be added to the overhead fluid system based on the value of the at least one fluid parameter where the fluid parameter is selected from the group consisting of:
pH,
temperature,
pressure,
density,
flow rate,
water wash rate,
total steam,
presence or level of a compound selected from the group consisting of chloride, total amine, total nitrogen, ammonia, halogen, bromide, iodide, oxygen, water, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutylamine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine, diisobutylamine, triethylamine, dimethylaminopropylamine, and combinations thereof, and
combinations thereof.

21. The system of claim 13 further comprising an overhead line of a distillation column, where the sensors are configured to estimate the value of a parameter of a fluid at the overhead line.

22. A computer readable medium product having stored thereon instructions that, when executed by at least one processor, perform a method the method comprising:
estimating an onset of corrosive species formation in real-time in an overhead fluid system using a value at least one parameter of a fluid where the fluid parameter is selected from the group consisting of:
pH,
temperature,
pressure,
density,
flow rate,
water wash rate,
total steam,
presence or level of a compound selected from the group consisting of: chloride, total amine, total nitrogen, ammonia, halogen, bromide, iodide, oxygen, water, methylamine, dimethylamine, ethylamine, monoethanolamine, ethylenediamine, trimethylamine, n-propylamine, isopropylamine, monomethylethanolamine, n-butylamine, sec-butylamine, tert-butylamine, isobutylamine, diethylamine, pyrrolidine, ethyldimethylamine, dimethylethanolamine, 3-methoxypropylamine, diethanolamine, dimethylisopropanolamine, methyldiethanolamine, morpholine, piperidine, cyclohexylamine, diethylethanolamine, di-n-propylamine, diisopropylamine, n-methylmorpholine, n-eththylmorpholine, di-n-butylamine, diisobutylamine, triethylamine, dimethylaminopropylamine, and combinations thereof, and
combinations thereof.

23. The computer-readable medium of claim 22 further comprising at least one of: (i) a ROM, (ii) an EPROM, (iii) an EEPROM, (iv) a flash memory, and (v) an optical disk.
